(19) United States
(12) Patent Application Publication
(10) Pub. No.: US 2021/0319374 A1
(43) Pub. Date: Oct. 14, 2021

(54) UTILIZING A COMBINATORIAL ACCOUNTABILITY FRAMEWORK DATABASE SYSTEM FOR RISK MANAGEMENT AND COMPLIANCE

(71) Applicant: TrustArc Inc, San Francisco, CA (US)

(72) Inventors: Hilary M. Wandall, Center Valley, PA (US); Terry McQuay, Toronto (CA); Joanne Furtsch, Sacramento, CA (US); Meaghan McCluskey, Toronto (CA)

(21) Appl. No.: 17/227,150

(22) Filed: Apr. 9, 2021

Related U.S. Application Data
(63) Continuation-in-part of application No. PCT/US21/21584, filed on Mar. 9, 2021.
(60) Provisional application No. 63/007,934, filed on Apr. 9, 2020.

(51) Int. Cl. G06Q 10/06; G06F 16/22

(52) U.S. Cl. CPC G06Q 10/0635; G06F 16/2272

(57) ABSTRACT

A method, system and/or computer usable program product for utilizing a combinatorial framework system for assessing risk management and compliance of an entity, including obtaining a master framework database for automating the management of an risk management and compliance program, the master framework database including a first framework database directed to mapping activities of the entity, the first framework also including comparable selected standard activities, and the master framework database including a second framework database directed to mapping controls of the entity, the second framework also including comparable selected standard controls, the first and second framework databases including cross referenced data elements; accessing the first framework database to generate a first risk management and compliance analysis of the activities of the entity compared with selected standard activities applicable to the entity; and accessing the second framework database to generate a second risk management and compliance analysis of the controls of the entity compared with selected standard controls applicable to the entity; wherein during the first and second risk management and compliance analysis of the activities and the controls of the entity, utilizing the cross referenced data elements to identify previously implemented activities and controls of the entity.

### PRIORITY CLAIM

This application claims priority to U.S. Provisional Application No. 63/007,934, filed Apr. 9, 2020, entitled “UTILIZING A COMBINATORIAL ACCOUNTABILITY FRAMEWORK DATABASE SYSTEM FOR RISK MANAGEMENT AND COMPLIANCE”, and is a continuation-in-part of PCT International Application No. PCT/US21/21584 filed Mar. 9, 2021, entitled “UTILIZING A COMBINATORIAL ACCOUNTABILITY FRAMEWORK DATABASE SYSTEM FOR RISK MANAGEMENT AND COMPLIANCE”, the disclosures of which are incorporated in their entirety herein by reference.

### BACKGROUND

### Technical Field

The present invention relates generally to utilizing a combinatorial accountability framework database system, and more specifically to a computer implemented method for utilizing a combinatorial accountability framework database system across multiple user groups for risk management and compliance.

### Description of Related Art

Various frameworks and databases have been developed and commercialized for a variety of purposes by multiple companies. For example, various companies have developed privacy frameworks to help customer entities identify and manage privacy risk in their systems and services while protecting the privacy rights of employees, customer, and other individuals interacting with those systems and services.

### SUMMARY

The illustrative embodiments of the present invention provide a method, system and/or computer usable program product for utilizing a combinatorial framework system for assessing risk management and compliance of an entity, including obtaining a master framework database for automating the management of an risk management and compliance program, the master framework database including a first framework database directed to mapping activities of the entity, the first framework also including comparable selected standard activities, and the master framework database including a second framework database directed to mapping controls of the entity, the second framework also including comparable selected standard controls, the first and second framework databases including cross referenced data elements; accessing the first framework database to generate a first risk management and compliance analysis of the activities of the entity compared with selected standard activities applicable to the entity; and accessing the second framework database to generate a second risk management and compliance analysis of the controls of the entity compared with selected standard controls applicable to the entity; wherein during the first and second risk management and compliance analysis of the activities and the controls of the entity, utilizing the cross referenced data elements to identify previously implemented activities and controls of the entity.

### BRIEF DESCRIPTION OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 provides a block diagram of an illustrative data processing system in which various embodiments of the present disclosure may be implemented;

FIG. 2 provides a block diagram of an illustrative network of data processing systems in which various embodiments of the present disclosure may be implemented;

FIGS. 3A-3C provide diagrams of processes for providing a scalable and customizable automated system for managing risk and compliance within a complex non-automated regulatory environment, in which various embodiments of the present disclosure may be implemented

FIGS. 4A and 4B provide high level diagrams of utilizing a combinatorial framework database system for risk management and compliance, in which various embodiments of the present disclosure may be implemented;

FIG. 5 provides a high level diagram of hierarchically structured levels in which various embodiments of the present invention may be implemented;

FIG. 6 provides a block diagram of an indexed core control framework 610 and a privacy management category framework 620 being cross-mapped into a combinatorial framework 600, in which various embodiments of the present invention may be implemented and

FIGS. 7A-7D provide textual diagrams of the framework database system and its application in which various embodiments of the present invention may be implemented.

### DETAILED DESCRIPTION

Processes and devices may be implemented and utilized for utilizing a combinatorial framework system for risk management and compliance. These processes and apparatuses may be implemented and utilized as will be explained with reference to the various embodiments below.

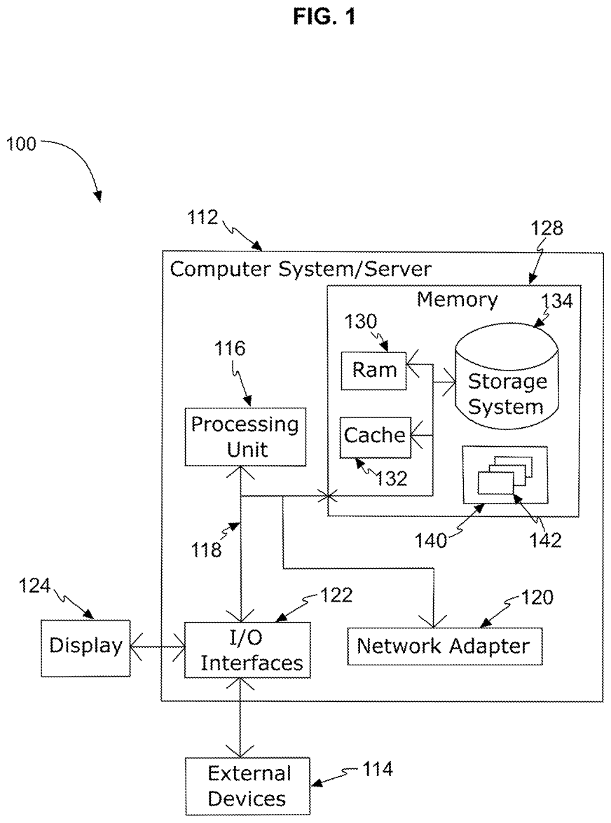

FIG. 1 provides a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as utilizing a combinatorial framework system for risk management and compliance.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices. For example, the present invention may be implemented in a cloud computing environment, distributed or otherwise, which may be virtualized such as with the use of a hypervisor managing multiple nodes including virtual processors, virtual memory, etc.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system readable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for utilizing a combinatorial framework system for risk management and compliance.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

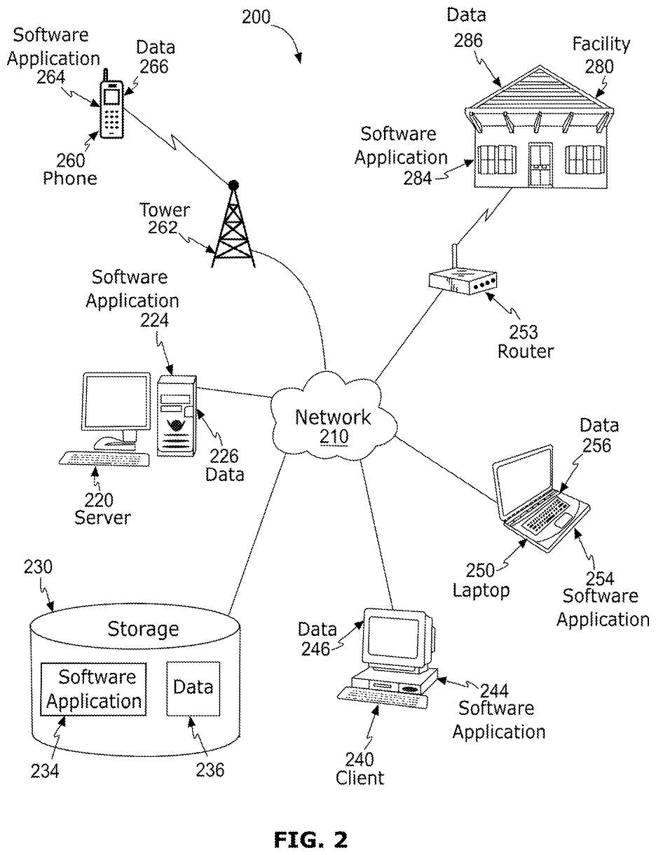

FIG. 2 provides a block diagram of an illustrative network of data processing systems in which various embodiments of the present disclosure may be implemented. Data processing environment 200 is a network of data processing systems such as described above with reference to FIG. 1. Software applications such as for utilizing a combinatorial framework system for risk management and compliance may be processed on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile device 260 such as a mobile phone may be coupled to network 210 through a cell tower 262. Data processing systems, such as server 220, client 240, laptop 250, mobile device 260 and facility 280 contain data and have software applications including software tools processing thereon. Other types of data processing systems such as personal digital assistants (PDAs), smartphones, tablets and netbooks may be coupled to network 210.

Server 220 may include software application 224 and data 226 for utilizing a combinatorial framework system for risk management and compliance or other software applications and data in accordance with embodiments described herein. Storage 230 may contain software application 234 and a content source such as data 236 for utilizing a combinatorial framework system for risk management and compliance. Other software and content may be stored on storage 230 for sharing among various computer or other data processing devices. Client 240 may include software application 244 and data 246. Laptop 250 and mobile device 260 may also include software applications 254 and 264 and data 256 and 266. Facility 280 may include software applications 284 and data 286 on local data processing equipment. Other types of data processing systems coupled to network 210 may also include software applications. Software applications could include a web browser, email, or other software application for utilizing a combinatorial framework system for risk management and compliance.

Server 220, storage unit 230, client 240, laptop 250, mobile device 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile device 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

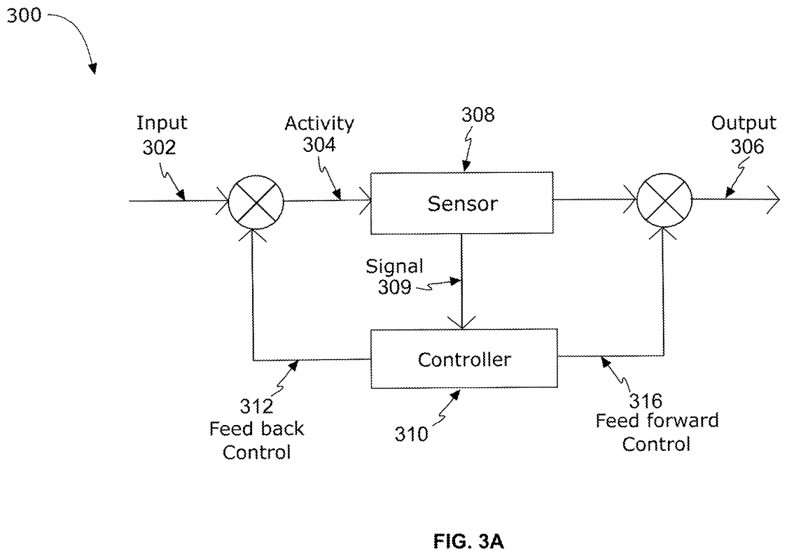

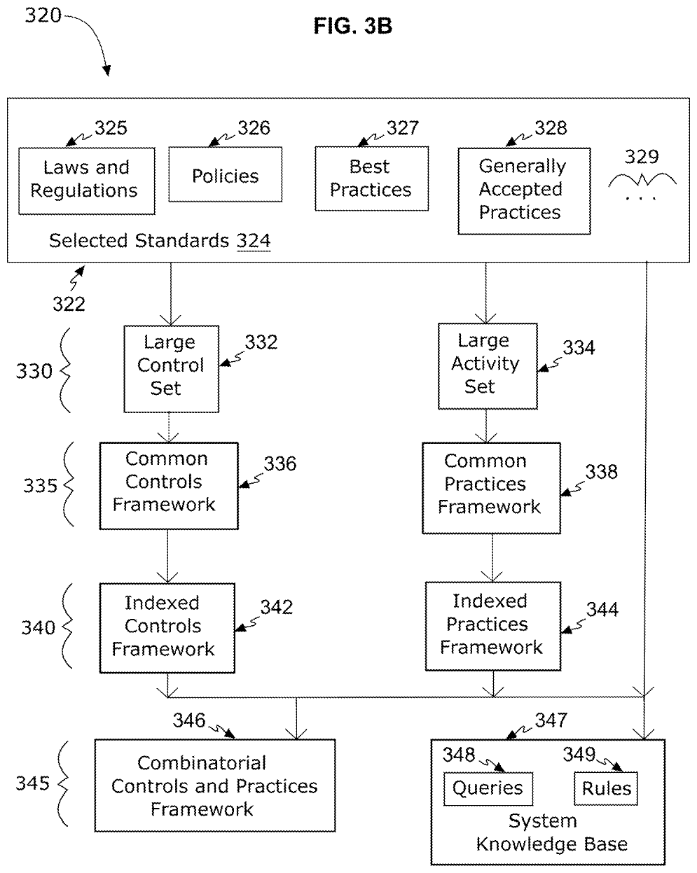

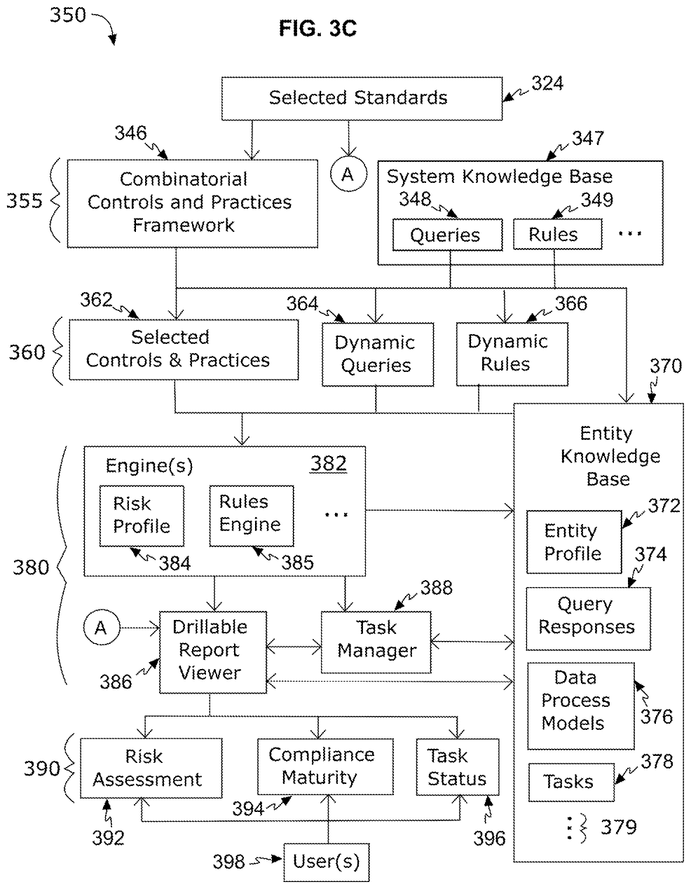

FIGS. 3A-3C provide diagrams of processes for providing a scalable and customizable automated system for managing risk and compliance within a complex non-automated regulatory environment, in which various embodiments of the present disclosure may be implemented.

FIG. 3A provides a block diagram 300 of a simplified system for providing compliance with selected standards, in which various embodiments of the present disclosure may be implemented. Block diagram 300 is described herein with reference to a risk management and compliance environment such as an entity managing risk and compliance within a data protection and privacy regulatory environment. Well known examples of such data protection and privacy regulations include GDPR (General Data Protection Regulation), CCPA (California Consumer Privacy Act), HIPAA (Health Insurance Portability and Accountability Act), etc. An entity such as a corporation may be subject to multiple such data protection and privacy regulations, making risk management and compliance a complicated, difficult and expensive effort that is very difficult to automate.

As shown in FIG. 3A, an input 302 is provided or received and an activity 304 is utilized upon that input to provide a desired output 306. The results of activity 304 may be assessed and documented by sensor 308, which then generates sensor signal 309 indicating the results of the sensor assessment and provides signal 309 to controller 310. Selected standards are then applied by controller 310 to sensor signal 309, resulting in feedback control 312 affecting 314 future inputs 302 and/or feedforward control 316 affecting 318 the current and optionally prior output 306. In the present embodiment, the activities and controls should be deconstructed to simplified actions and controls taken if a given selected standard applies. That is, generally stated activities and controls from selected standards should be broken down into simplified declaratory statements that can be implemented in software. For example, in the present embodiment, where data protection and privacy regulations apply, a new data element type, collected and stored in an entity's databases, should be reviewed and assessed for sensitivity. That is, a new type of data being collected and stored should be reviewed and assessed as to whether it may be in a protected class of data (e.g., medical information about an individual). Input 302 would be the new data type, activity 304 could be the act of reviewing and assessing the new data type for sensitivity, and output 306 could be the result of that activity, such as a classification of that new data type as sensitive or not. Sensor 308 could include assessing whether the new data type was classified and creating an audit trail of that classification for future analysis and verification of the system's compliance. Controller 310 could include a determination whether the assessed classification was successful or not in accordance with certain standards for classification of new data types with the results stored as an audit trail for future analysis and verification of the system's compliance. Based on the results of the applied standards, feedback control 312 could be generated to affect future classification activities 314, such as recommending a need for training of the persons conducting the classifications. This would help prevent future misclassifications of the new data types. Also based on the results of the applied standards, feedforward control 316 could be generated to affect prior classification activities 318, such as recommending an audit of prior data type classifications to correct and prior misclassifications.

There is a need for both activities and controls in such a system for long term stability and success. For example, certain activities need to be implemented for accomplish the desired outputs or results from given inputs. However, controls are needed for ensuring that the activities are continuing as planned over a long period of time. As known by those of ordinary skill in the art, whether in technical or business contexts, any system of activities will eventually fall out of compliance with desired results without controls to maintain that compliance. For example, in the present embodiment, personnel instructed to classify new data types may do so for a period of time. However, as new personnel are hired, they may not learn about or perform that classification correctly. As a result, the results of the classification activity should be assessed and documents, applied to predetermined standards, and corrective action taken through feedback and/or feedforward controls. These actions and controls may also be implemented in a production environment as a form of real-time gatekeeper. This gatekeeper function can exist within an entity such as to allow an employee to view certain data or not depending on their role within the entity. This gatekeeper function can also exist between the entity and other entities such as where an employee of the entity seeks to share certain information on-line with employees of other entities. This gatekeeper function can further exist to an e-commerce environment to permit or not permit commercial transactions in order to comply with applicable standards.

FIG. 3B provides a high level diagram of a process 320 for providing a scalable automated system for managing risk and compliance within a complex non-automated regulatory environment, in which various embodiments of the present disclosure may be implemented. This process may be performed by a developer of an overall system, with FIG. 3C directed to an entity utilizing a subset of the overall system applicable to that entity.

In a first step 322, a global set of selected standards 324 are collected for developing this scalable automated risk management and compliance system including relevant laws and regulations 325, policies 326, best practices 327, generally accepted practices 328, and any other relevant sources of standards. This global set of selected standards is dynamic such that it can be updated with new or modified sources of standards. In a second step 330, a large set of controls 332 and a large set of activities 334 are generated that would provide risk management and compliance within the various selected standards. This involves breaking down the requirements and recommendations within the selected standards down to codeable detailed activities and controls such as described with reference to FIG. 3A above. In the case of controls, there may be more focus upon the laws, regulations and policies, whereas in the case of activities, there may be more of a focus upon the best practices and generally accepted practices. While generating these large sets of controls and activities, a general dictionary of common terms may be developed for standardization of terminology across the selected standards. In addition, synonyms may be mapped against the common terms for indexing back to the original text of the selected standards. Then in a third step 335, the large sets of controls and activities may be distilled into a framework of common controls 336 and a framework of common practices 338 including subunits of each common control and common practice. The combination of various tightly related activities are now referred to a common practices or as practices herein to reflect the collective aspect of those activities. These frameworks may be incorporated into relational or other types of databases for scalability, further configuration, and automated utilization. The frameworks of common controls and common practices produced by this distillation process may not be a perfect fit for utilization of each of the selected standards, but close enough for reasonable application of those selected standards.

In a fourth step 340, the common controls framework and the common practices framework, including subunits thereof, are indexed 342 and 344 to the laws and regulations. This allows for an easier determination of compliance with those laws and regulations. Then in step 345, the indexed frameworks of common controls and common practices are converged through cross-mapping into a combinatorial common controls and practices framework 346. This combinatorial framework may be two separate frameworks that are cross-indexed with each other or a single framework that encompasses both controls and practices. In addition, system knowledge base 347 is generated including a set of queries 348 and a set of rules 349. Queries 348 may be utilized for applying the combinatorial common controls and practices framework to an entity and documenting the results thereof. Queries 348 may be applied automatically against a user profile or user documented processes and/or manually with a user through a user interface, such as described below with reference to FIG. 3C. Rules 349 are generated for utilizing the query documentation and generating reports showing risk management and compliance with the selected standards, such as described below with reference to FIG. 3C. Combinatorial controls and practices framework 346, queries 348 and rules 349 are dynamic in that they can be modified over time, such as when additional laws or best practices are identified and utilized in selected standard 324.

In an alternative embodiment, the process of FIG. 3B may be initiated with a single framework which includes both practices and controls derived from a set of selected standards. That single framework may then be split into two separate frameworks of controls and activities, which are then processed as described above, including converging those split frameworks into a single combinatorial framework. Other alternative embodiments could utilize other methods for generating a combinatorial framework of controls and practices, as known to those of ordinary skill in the art.

FIG. 3C provides a high level diagram of a process 350 for providing a customizable automated system for managing risk management and compliance within a complex non-automated regulatory environment, in which various embodiments of the present disclosure may be implemented. This process may be performed by an entity, with FIG. 3C directed to the entity utilizing a subset of the overall system applicable to that entity.

In a first step 355, this process starts with selected standards 324, combinatorial controls and practices framework 346 and system knowledge base 347, each of which is global in coverage and only portions of which may be applicable or of interest to a given entity. Then in a second step 360, certain queries 348 and rules 349 are applied to determine which of the controls and practices and which elements of the system knowledge base may be applicable for a given entity. For example, there may be a query as to whether the entity conducts business in or with the European Union. If so, then the GDPR may apply, so certain controls and practices 362, queries 364 and rules 366 may be downloaded or otherwise selected for utilization from framework 346 and knowledge base 347. A separate combinatorial framework and system knowledge base may be downloaded in accordance with this selection process to a user's servers, or a database with linkages to selected portions of framework 346 and system knowledge base 347 may be maintained to indicate the selected portions thereof. In addition, an entity knowledge base 368 is generated and built utilizing query results, inputs from users, and other sources as described herein. Entity knowledge base 370 may include an entity profile 372, query responses 374, data process models 376, tasks 378, and other relevant information 379 regarding the entity. Entity profile 372 may include information such as entity name, place(s) of business, number of employees, annual revenue, and other information regarding the entity that may be applicable in determining the applicability of certain laws and other standards and the applicability of those laws and other standards. Query responses 376 includes the entity's initial responses to queries 348 and later to queries 364. Data process models 376 includes models of relevant portions of the entity's operations, typically generated in response to tasks 378 as described below.

In a third step 380, various engine(s) 382 may perform analysis and provide information to a drillable report viewer 386 and task manager 388. Engine(s) 382 may include a rules engine 385 which utilizes dynamic rules 366 and entity knowledge base 370 for analyzing and determining whether the entity is in compliance with the selected controls and practices 362. This rules engine analysis and determinations may be provided to drillable report viewer 386 for generating reports and for entity user interaction. This rules engine analysis and determinations may also be provided to task manager 388 for initiating and managing tasks for addressing the results of that analysis and determinations. Engine(s) 382 may also include a risk profile engine 384 which utilizes the results of rules engine 385 and entity knowledge base 370 for generating a risk profile of the entity describing the maturity of the entity's compliance with the selected controls and practices 362. This risk profile may be provided to drillable report viewer 386 for generating reports and for entity user interaction. This risk profile may also be provided to task manager 388 for initiating and managing tasks for addressing the results of that analysis and determinations.

In a fourth step 390, user 398 may interact with risk assessment 392, compliance maturity 394 and tasks status 396 to receive risk management and compliance information towards understanding the results of the above described processes and to take steps to react to the risk management and compliance information. For example, user 398 may select additional standards from selected standards 324 for processing as described above. In addition, user 398 may generate tasks with task manager 388 to address any con-compliance and/or to reduce risk of non-compliance. User 398 may also access the underlying selected standards through drillable report viewer 386.

Combinatorial controls and practices framework 362, queries 364 and rules 366 are dynamic in that they can be automatically modified over time, such as when additional laws or best practices are modified in selected standard 324 or if the entity user selects different controls and practices from framework 346. Furthermore, such modifications of framework 362, queries 364 and 366 may be automatic upon a change in underlying selected standards 324 or modified user selection of selected controls and practices 346. An entity user may similarly and automatically simulate changes to the entity's business or selected standards by running simulated “what ifs” to entity knowledge base 370 or selection from controls and practices framework 346.

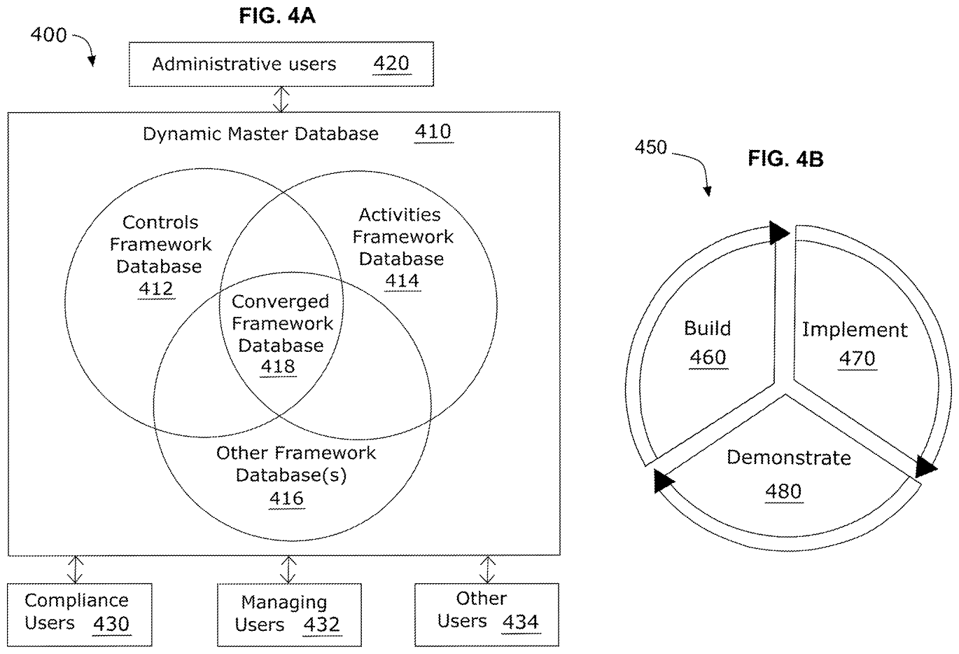

FIGS. 4A and 4B provide high level diagrams of utilizing a combinatorial framework database system for risk management and compliance, in which various embodiments of the present disclosure may be implemented. FIG. 4 provides a high level block diagram 400 of utilizing a combinatorial framework database system for risk management and compliance, in which various embodiments of the present disclosure may be implemented. Combinatorial framework database system 400 includes a dynamic master database 410, also referred to herein as a combinatorial framework, that interacts with several user types including administrative users 420, compliance users 430, management users 440 and other users 450.

Dynamic master database includes a controls framework database 412, an activities framework database 414 and other framework database(s) 416. Controls framework database 412, activities framework 414 and other framework database(s) 416 include converged content and functionality shown as converged framework database 418. Converged framework database 418 includes elements that may overlap between controls framework database 412, activities framework database 414 and other framework database(s) 416. Converged framework database 418 may also include integrated functionality made practical by the convergence of controls framework database 412, activities framework database 414 and other framework database(s) 416, such as providing a comparison of activities and/or best practices information with compliance information as part of assessing risk. For purposes of this embodiment, converged framework database 418 may be included as part of controls framework database 412, included as part of activities framework database 414, and included as part of other framework database(s) 416. In the present embodiment, combinatorial framework database system 400 may be utilized by an entity for risk management, such as for privacy and data governance by that entity. An entity may be a single entity or multiple entities that have been grouped together. Combinatorial framework system 400 includes dynamic master database 410 that may be accessed by multiple user types for multiple purposes, including risk management. In alternative embodiments, controls framework database 412, activities framework database 414 and other framework database(s) 416 may be simulated as fixed structure data elements within dynamic master database 410 along predetermined configurations as needed dynamically by the users.

In the present embodiment, these framework databases may be utilized by various users types including administrative users, compliance users, managing users, and other users as needed. Each user may be provided access to all framework databases or selected framework databases. This access may be provided and authorized by administrative users or other pre-authorized users. For this embodiment, a single user may be included as multiple user types and multiple users may be included in each user type. However, the users are segregated as shown herein for illustrative purposes demonstrating the dynamic nature of the present invention.

Administrative users 420 includes one or more users that manage dynamic master database 410 so that it includes the functionality needed for compliance users 430, managing users 432, and other users 434. This can include providing a profile of the entity or entities, documenting existing data types managed by the entity, documenting processes utilizing the data types, as well as other aspects of the entity and its processes which may be useful for managing risk. Administrative users 420 may not need to enter the same information repeatedly in controls framework database 412, activities framework database 414, and other framework database(s) 416 due to the common content and functionality of converged framework database 418.

Compliance users 430 may primarily utilize controls framework database 412 for assessing a risk level of non-compliance with certain rules and regulations by the entity, although activities framework database 414 may also be utilized in combination with controls framework database 412 as needed such as for assessing whether the entity is utilizing reasonable industry standard and/or best practices for managing certain risks. In addition, other framework database(s) 416 may be utilized in combination with controls framework database 412 for other functionality as well. Compliance users 430 may also generate certain tasks to be performed by administrative users 420 as well as flag information to be presented to managing users 432 and other users 434.

Managing users 432 may primarily utilize activities framework database 414 for assessing risks that the entity may be incurring as a result of its activities such as comparing the activities of the entity with industry standard and/or best practices of the industry or across multiple industries. Controls framework database 412 may also utilized in combination with activities framework database 414 as needed such as for assessing whether the entity is in compliance with certain rules and regulations. In addition, other framework database(s) 416 may be utilized in combination with activities framework database 414 as needed for other functionality as well. Managing users 432 may also generate certain tasks to be performed by administrative users 420 as well as flag information to be presented to compliance users 430 and other users 434.

Other users 434 may primarily utilize other framework database(s) 416 for other purposes such as records management for the entity, although controls framework database 412 may also utilized in combination with other framework database(s) 416 as needed such as for assessing whether such records management may comply with both privacy data governance requirements as well as general non-privacy records management requirements. In addition, activities framework database(s) 414 may also be utilized in combination with other framework database(s) 416 as needed such as for identifying whether such records management may comply with both privacy related best practices as well as general non-privacy records management best practices. Other users 434 may also generate certain tasks to be performed by administrative users 420 as well as flag information to be presented to compliance users 430 and managing users 432.

FIG. 4B provides a high level flow diagram 450 of utilizing a combinatorial framework database system for risk management and compliance, in which various embodiments of the present disclosure may be implemented. Flow diagram 450 includes three primary steps including build 460, implement 470, and demonstrate 480. These three primary steps 460, 470 and 480 are also referred to herein as pillars when implemented against selected standards to generated core controls and activities. Although numbered in sequence, these primary steps may be utilized and/or updated in parallel or in any sequence to meet the needs of the users such as those shown in FIG. 4A above. FIG. 4B is described with reference to the elements of FIG. 4A, including the users and framework databases. For example, in the present embodiment, FIG. 4B is described with reference to privacy and data governance accountability framework databases such as controls database 412 and activities framework database 414.

In the present embodiment, build 460 includes designing, establishing, and managing a program to ensure effective governance, risk management, policies, processes, and accountability. This can including building the various framework databases to meet the needs of the various users. In the present embodiment, implement 470 includes defining data needs, identifying data processing risks, ensuring the data processing is lawful, managing data flows and third parties, addressing individual rights, as well as providing data security, data quality, and transparency. This can include implementing the various framework databases to meet the needs of the various users. In the present embodiment, demonstrate 480 includes monitoring, evaluating, and reporting on compliance, control effectiveness, risk, and maturity. This can include utilizing the various framework databases demonstrating these capabilities for meeting the needs of the various users.

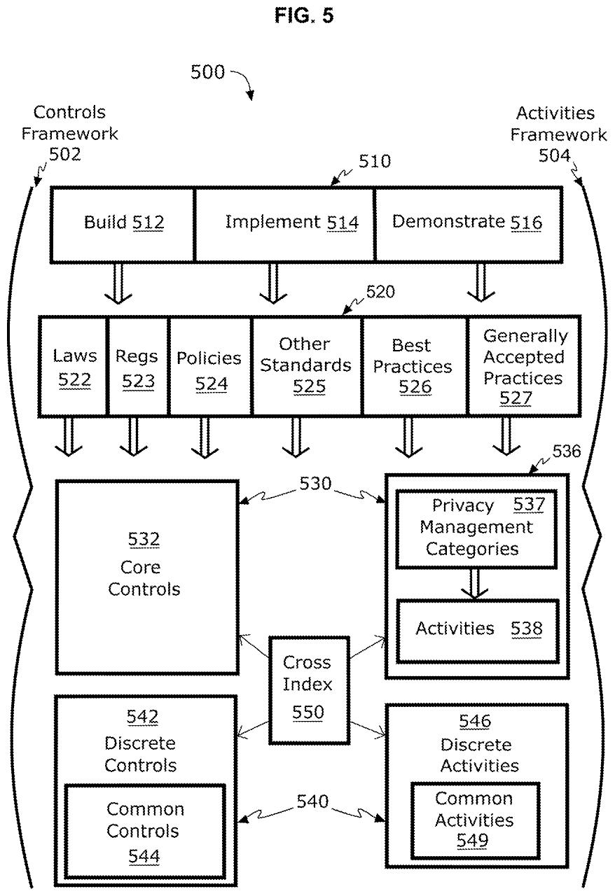

FIG. 5 provides a high level diagram 500 of hierarchically structured levels in which various embodiments of the present invention may be implemented. These hierarchically structures levels can be organized into a controls framework 502 and an activities framework 504, such as described herein. At a first level 510 are three pillars shown as build 512, implement 514 and demonstrate 516, which are described in greater detail above, such as with reference to FIG. 4B. Alternative embodiments may utilize a different set of pillars or steps in organizing the various levels shown herein into a cohesive and effective combinatorial framework data system for risk management and compliance.

The three pillars 510 are then applied against selected standards 520 (a second level of the hierarchical structure) to generate third level 530. Selected standards 520 may include laws 522, regulations 523, policies 524, other standards 525, best practices 526 and generally accepted practices 527. Other categories of selected standards may be included/utilized or not included/utilized. Third level 530 may include core controls 532 and accountability 536. In the present embodiment, both core controls 532 and accountability 536 may be derived from various selected standards 520 with core controls focusing on controls in those selected standards and accountability focusing on activities in those selected standards. In the present embodiment, accountability 536 may include a select set of privacy management categories (PMCs) 537 which can be further broken down into activities 538. Third level 530 may be deconstructed into fourth level 540 including discrete controls 542 and discrete activities 546. These are low level controls and activities which may be utilized as parts of tasks towards risk management and compliance. Discrete controls 542 may include common controls 544, which are core controls that are utilized repeatedly, such as across multiple selected standards. Activities 546 may include common activities 549, which are activities that are utilized repeatedly, such as across multiple best practices.

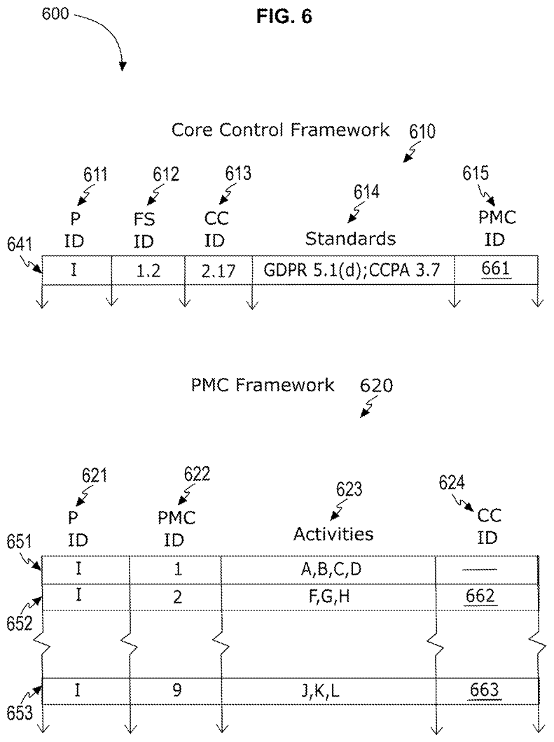

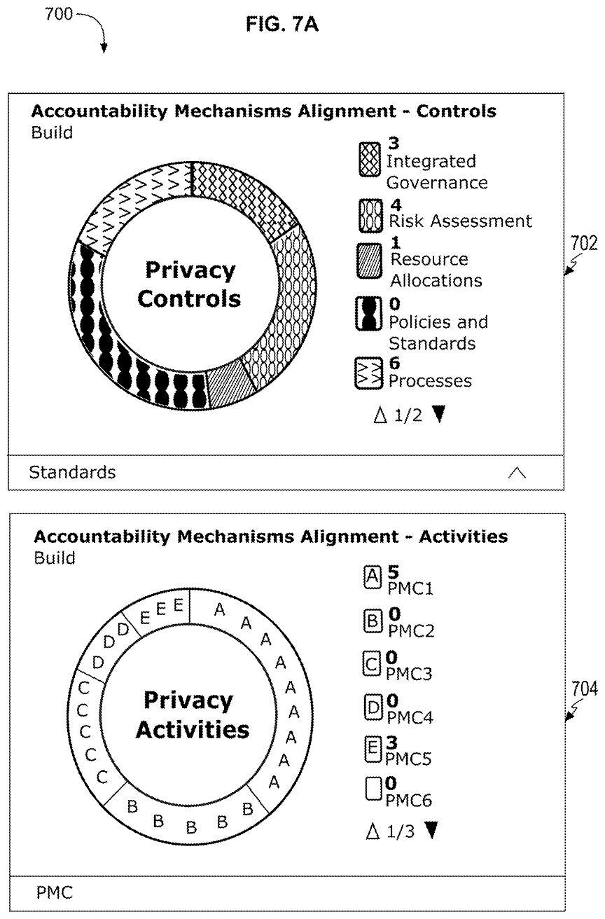

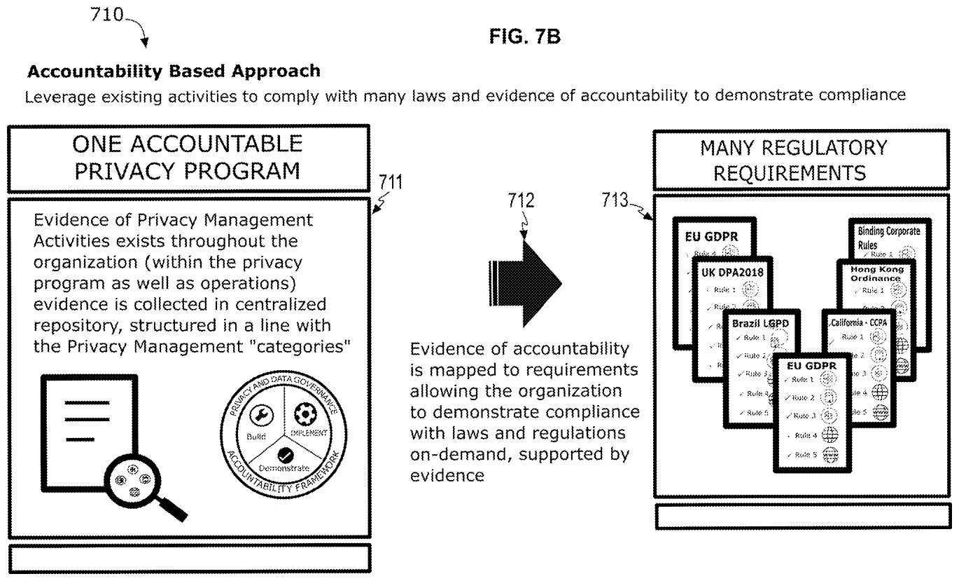

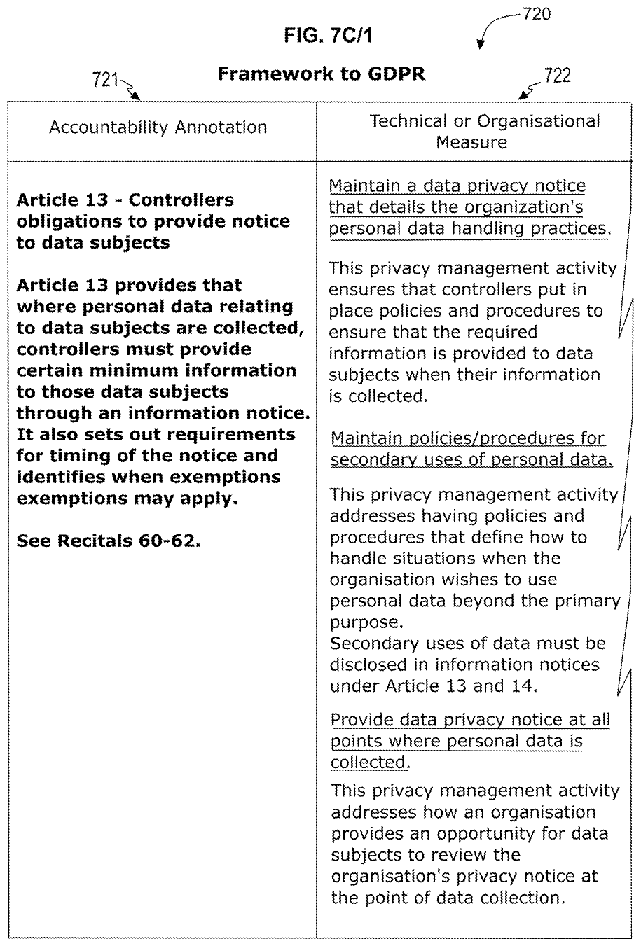

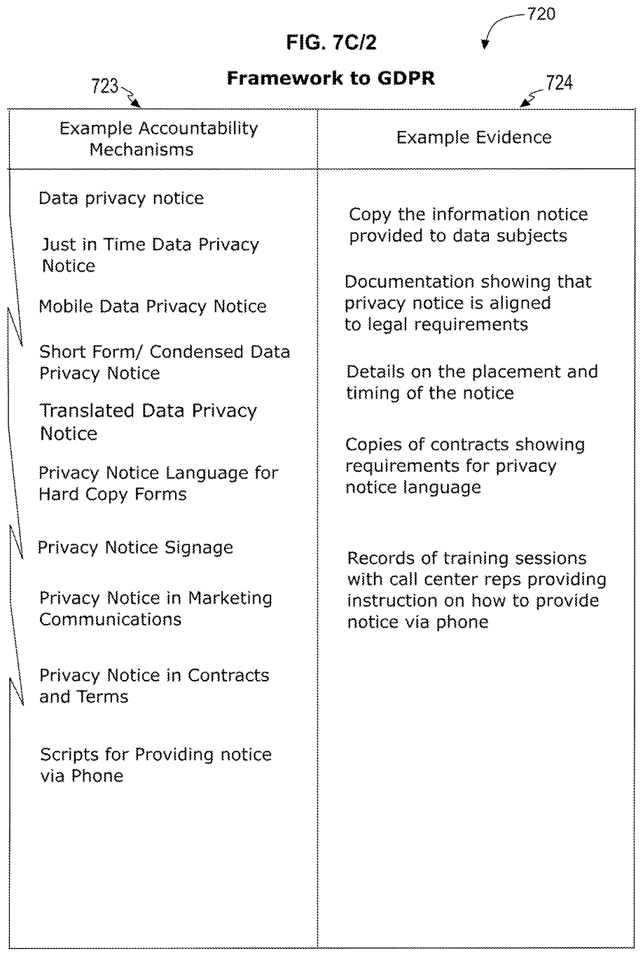

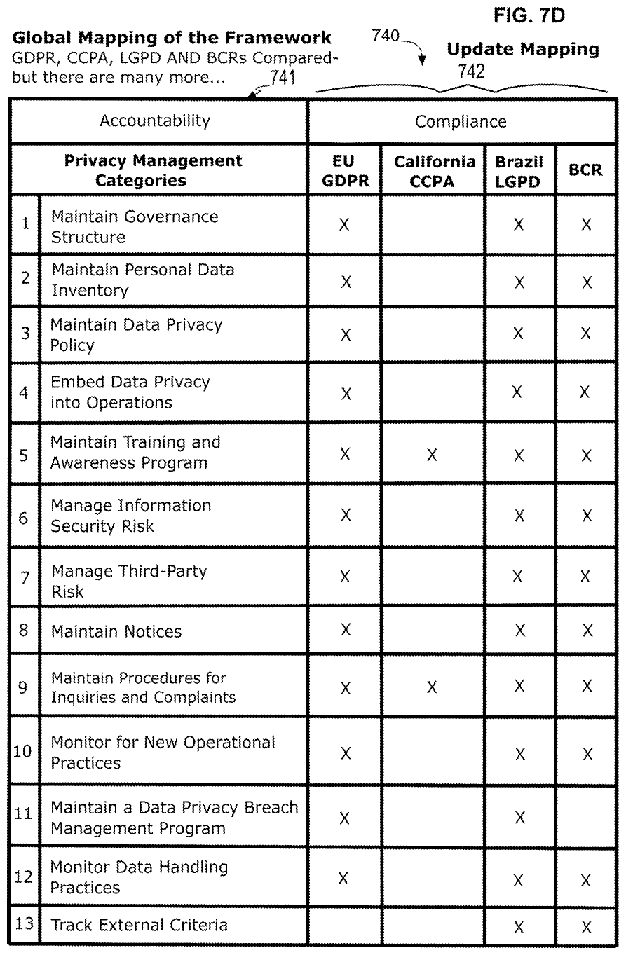

In the present embodiment, controls framework 502 and an activities framework 504 may be cross indexed with each other through cross index 550 referencing core controls 532, activities 538, discrete controls 542 and discrete activities 546 such as described in greater detail below with reference to FIG. 6. In the present embodiment, this cross referencing is at a level whereby duplication of effort in requirements and tasks can be reduced while also allowing parallel views of data from both frameworks (e.g., see FIG. 7A described below). Alternative embodiments may structure a combinatorial framework(s) in other ways as needed depending on the desired capabilities and efficiencies.

There are privacy management and data governance categories, standards, activities and core controls for building, implementing and demonstrating privacy and data governance programs utilizing accountability framework databases, in which various embodiments of the present invention may be implemented. This includes privacy management categories for managing activities framework database 414 (also referred to herein as practices framework database, framework standards for managing controls framework database 412, and core controls for managing framework database 412. Alternative embodiments may utilize other sets of categories, standards, core controls, or other forms of categorization for other types of framework databases and other types of applications of those framework databases.

The below description is directed to privacy management categories for managing framework database 414. As shown in the present embodiment, there are 13 privacy management categories, shown as PMC1 through PMC13 (PMC1—Maintain Governance Structure, PMC2—Maintain Personal Data Inventory and Data Transfer Mechanisms, PMC3—Maintain Internal Data Privacy Policy, PMC4—Embed Data Privacy Into Operations, PMC5—Maintain Training and Awareness Program, PMC6—Manage Information Security Risk, PMC7—Manage Third Party Risk, PMC8—Maintain Notices, PMC9—Respond to Requests and Complaints from Individuals, PMC10—Monitor for New Operational Practices, PMC11—Maintain Data Privacy Breach Management Program, PMC12—Monitor Data Handling Practices, and PMC13—Track External Criteria), which may be primarily utilized in managing activities framework database 414. These 13 privacy management categories may be considered common or high level activities or practices among many different best practices, generally accepted practices, laws, regulations, etc. There may also be many subunits within each such privacy management category. Some of these privacy management categories are utilized in building (PMC1-PMC7, PMC9-PMC11 and PMC 13), some in implementing (PMC2-PMC4, PMC6-PMC9 and PMC11), and some in demonstrating (PMC1-PMC3 and PMC5-PMC 12), which may be utilized in managing activities framework database 414. In this embodiment, there is an overlap among the various privacy management categories as described herein. However, this overlap is by privacy management category generally, but there are specifics in each privacy management category that differ. Examples of each are described below.

PMC1 (Maintain Governance Structure) in build 460 includes assign responsibility for data privacy to an individual (e.g. Privacy Officer, General Counsel, CPO, CISO, EU Representative); engage senior management in data privacy (e.g. at the Board of Directors, Executive Committee); appoint a Data Protection Officer (DPO) in an independent oversight role; assign responsibility for data privacy throughout the entity (e.g. privacy network); maintain roles and responsibilities for individuals responsible for data privacy (e.g. job descriptions); conduct regular communication between the privacy office, privacy network, and others responsible/accountable for data privacy; engage stakeholders throughout the entity on data privacy matters (e.g. information security, marketing, etc.); conduct an Enterprise Privacy Risk Assessment; integrate data privacy into business risk assessments/reporting; maintain a Privacy Strategy; maintain a privacy program charter/mission statement; and require employees to acknowledge and agree to adhere to the data privacy policies. PMC1 in demonstrate 470 includes report to internal stakeholders on the status of privacy management (e.g. board of directors, management); and report to external stakeholders on the status of privacy management (e.g. regulators, third-parties, clients). PMC1 in demonstrate 480 includes report to internal stakeholders on the status of privacy management (e.g. board of directors, management); and report to external stakeholders on the status of privacy management (e.g. regulators, third-parties, clients).

PMC2 (Maintain Personal Data Inventory and Data Transfer Mechanisms) in build 460 includes maintain an inventory of personal data and/or processing activities; classify personal data by type (e.g. sensitive, confidential, public); and maintain documentation of data flows e.g. between systems, between processes, between countries). PMC2 in implement 470 includes maintain documentation of the transfer mechanism used for cross-border data flows (e.g., model clauses, BCRs, regulatory approvals); use contracts as a data transfer mechanism (e.g. Standard Contractual Clauses); and use adequacy or one of the derogations (e.g. consent, performance of a contract, public interest) as a data transfer mechanism. PMC2 in demonstrate 480 includes use Binding Corporate Rules as a data transfer mechanism; use APEC Cross Border Privacy Rules as a data transfer mechanism; use Privacy Shield as a data transfer mechanism; obtain regulatory approval for data processing (where prior approval is required); register databases with regulators (where registration is required); and use regulatory approval as a data transfer mechanism. PMC2 in demonstrate 480 includes use Binding Corporate Rules as a data transfer mechanism; use APEC Cross Border Privacy Rules as a data transfer mechanism; use Privacy Shield as a data transfer mechanism; obtain regulatory approval for data processing (where prior approval is required); register databases with regulators (where registration is required); and use regulator approval as a data transfer mechanism

PMC3 (Maintain Internal Data Privacy Policy) in build 460 includes maintain a data privacy policy; and maintain an employee data privacy policy. PMC3 in implement 470 includes document legal basis for processing personal data. PMC3 in demonstrate 480 includes maintain an organizational code of conduct that includes privacy; and integrate ethics into data processing (Codes of Conduct, policies, and other measures).

PMC4 (Embed Data Privacy into Operations) in build 460 includes maintain policies/procedures to review processing conducted wholly or partially by automated means. PMC4 in implement 470 includes maintain policies/procedures for collection and use of sensitive personal data (including biometric data); maintain policies/procedures for collection and use of children's and minors' personal data; maintain policies/procedures for maintaining data quality; maintain policies/procedures for the de-identification of personal data; maintain policies/procedures to review processing conducted wholly or partially by automated means; maintain policies/procedures for secondary uses of personal data; maintain policies/procedures for obtaining valid consent; maintain policies/procedures for secure destruction of personal data; integrate data privacy into use of cookies and tracking mechanisms; integrate data privacy into records retention practices enforcement purposes; integrate data privacy into research practices (e.g. scientific and historical research); integrate data privacy into direct marketing practices; integrate data privacy into email marketing practices; integrate data privacy into telemarketing practices; integrate data privacy into digital advertising practices (e.g. online, mobile); integrate data privacy into hiring practices; integrate data privacy into the entity's use of social media; integrate data privacy into Bring Your Own Device (BYOD) policies/procedures; integrate data privacy into health & safety practices; integrate data privacy into interactions with works councils; integrate data privacy into practices for monitoring employees; integrate data privacy into use of CCTV/video surveillance; integrate data privacy into use of geo-location (tracking and/or location) devices; integrate data privacy into policies/procedures regarding access to employees' company email accounts; integrate data privacy into e-discovery practices; integrate data privacy into conducting internal investigations; and integrate data privacy into practices for disclosure to and for law enforcement purposes.

PMC5 (Maintain Training and Awareness Program) in build 460 includes conduct privacy training; conduct privacy training reflecting job specific content; conduct regular refresher training; incorporate data privacy into operational training (e.g. HR, marketing, call center); deliver training/awareness in response to timely issues/topics; provide a repository of privacy information (e.g. an internal data privacy intranet); maintain privacy awareness material (e.g. posters and videos); conduct privacy awareness events (e.g. an annual data privacy day/week); enforce the requirement to complete privacy training; provide ongoing education and training for the Privacy Office and/or DPOs; and maintain qualifications for individuals responsible for data privacy, including certifications. PMC5 in demonstrate 480 includes measure participation in data privacy training activities (e.g. number of participants, scoring).

PMC6 (Manage Information Security Risk) in build 460 includes maintain an acceptable use of information resources policy. PMC6 in implement 470 includes integrate data privacy risk into security risk assessments; integrate data privacy into an information security policy; maintain technical security measures (e.g. intrusion detection, firewalls, monitoring); maintain measures to encrypt personal data; maintain procedures to restrict access to personal data (e.g. role-based access, segregation of duties); integrate data privacy into a corporate security policy (protection of physical premises and hard assets); maintain human resource security measures (e.g. pre-screening, performance appraisals); integrate data privacy into business continuity plans; and maintain a data-loss prevention strategy. PMC6 in demonstrate 480 includes conduct regular testing of data security posture; and maintain a security certification (e.g. ISO).

PMC7 (Manage Third Party Risk) in build 460 includes maintain data privacy requirements for third parties (e.g. clients, vendors, processors, affiliates); conduct due diligence on third party data sources; maintain a vendor data privacy risk assessment process; maintain a policy governing use of cloud providers; and maintain procedures to address instances of non-compliance with contracts and agreements. PMC7 in implement 470 includes maintain procedures to execute contracts or agreements with all processors; conduct due diligence around the data privacy and security posture of potential vendors/processors; and review long-term contracts for new or evolving data privacy risks. PMC7 in demonstrate 480 includes conduct due diligence around the data privacy and security posture of existing vendors/processors.

PMC8 (Maintain Notices) in implement 470 includes maintain a data privacy notice; provide data privacy notice at all points where personal data is collected; provide notice by means of on-location signage, posters; provide notice in marketing communications (e.g. emails, flyers, offers); provide notice in contracts and terms; maintain scripts for use by employees to explain or provide the data privacy notice. PMC8 in demonstrate 480 includes maintain a privacy seal or trustmark on the website to increase customer trust.

PMC9 (Respond to Requests and Complaints from Individuals) in build 460 includes maintain procedures to address complaints; maintain procedures to respond to requests for access to personal data; maintain procedures to respond to requests and/or provide a mechanism for individuals to update or correct their personal data; maintain procedures to respond to requests to opt-out of, restrict, or object to processing; maintain procedures to respond to requests for information; maintain procedures to respond to requests for data portability; maintain procedures to respond to requests to be forgotten or for erasure of data; maintain Frequently Asked Questions to respond to queries from individuals; and investigate root causes of data privacy complaints. PMC9 in implement 470 includes implement procedures to respond to requests for access to personal data; implement procedures to respond to requests and/or provide a mechanism for individuals to update or correct their personal data; implement procedures to respond to requests to opt-out of, restrict, or object to processing; implement procedures to respond to requests for information; implement procedures to respond to requests for data portability; and implement procedures to respond to requests to be forgotten or for erasure of data. PMC9 in demonstrate 480 includes monitor and report metrics for data privacy complaints (e.g. number, root cause).

PMC10 (Monitor for New Operational Practices) in build 460 includes integrate Privacy by Design into data processing operations; maintain PIA/DPIA guidelines and templates; conduct PIAs/DPIAs for new programs, systems, and/or processes; conduct PIAs/DPIAs s for changes to existing programs, systems, or processes; engage external stakeholders (e.g. individuals, privacy advocates) as part of the PIA/DPIA process; and track and address data protection issues identified during PIAs/DPIAs. PMC10 in demonstrate 480 includes report PIA/DPIA analysis and results to regulators (where required) and external stakeholders (if appropriate).

PMC11 (Maintain Data Privacy Breach Management Program) in build 460 includes maintain a data privacy incident/breach response plan; maintain a log to track data privacy incidents/breaches; conduct periodic testing of data privacy incident/breach plan; engage a breach response remediation provider; engage a forensic investigation team; and obtain data privacy breach insurance coverage. PMC11 in implement 470 includes maintain a breach notification (to affected individuals) and reporting (to regulators, credit agencies, law enforcement) protocol. PMC11 in demonstrate 480 includes maintain a breach notification (to affected individuals) and reporting (to regulators, credit agencies, law enforcement) protocol; and monitor and report data privacy incident/breach metrics (e.g. nature of breach, risk, root cause).

PMC12 (Monitor Data Handling Practices) in demonstrate 480 includes conduct self-assessments of privacy management; conduct Internal Audits of the privacy program (i.e. operational audit of the Privacy Office); conduct ad-hoc walk-throughs; conduct ad-hoc assessments based on external events, such as complaints/breaches; engage a third party to conduct audits/assessments; monitor and report privacy management metrics; maintain documentation as evidence to demonstrate compliance and/or accountability; and maintain certifications, accreditations, or data protection seals for demonstrating compliance to regulators.

PMC13 (Track External Criteria) in build 460 includes identify ongoing privacy compliance requirements (e.g. law, case law, codes, etc.); maintain subscriptions to compliance reporting service/law firm updates to stay informed of new developments; attend/participate in privacy conferences, industry association, or think-tank events; record/report on the tracking of new laws, regulations, amendments, or other rule sources; seek legal opinions regarding recent developments in law; identify and manage conflicts in law; and document decisions around new requirements, including their implementation or any rationale behind decisions not to implement changes.

The below description is directed to framework standards for managing framework database 412. As shown in the present embodiment, there are 16 framework standards, shown as FS1 through FS16, which may be primarily utilized in managing controls framework database 412. These 16 framework standards may be considered high level controls among many different laws, regulations, best practices, generally accepted practices, etc. There may also be many subunits, referred to herein as core controls, within each such framework standard, some of which may be common controls. As described herein, some of these framework standards are utilized in building 460 (FS1-FS6), some in implementing 470 (FS7-FS14), and some in demonstrating 480 (FS15-FS16), which may be utilized in managing controls framework database 412.

Build includes 6 standards including: “FS1-Maintain Governance Structure: Identify stakeholders. Establish program leadership and governance. Define program mission, vision, and goals.”; “FS2-Risk Assessment: Identify, assess, and classify data-related strategic, operational, legal, compliance, and financial risks.”; “FS3-Resource Allocation: Establish budgets. Define roles and responsibilities. Assign personnel.”; “FS4-Policies and Standards: Develop policies, procedures, and guidelines to define and deploy effective and sustainable governance and controls for managing data related risks.”; “FS5-Processes: Establish, manage, measure, and continually improve processes for PIAs, vendor assessments, incident management and breach notification, compliant handling, and individual rights management.”; and “FS6-Awareness and Training: Communicate expectations. Provide general and contextual training.”.

Implement includes 8 standards including: “FS7-Data Necessity: Optimize data value by collecting and retaining only the data necessary for strategic goals. Leverage anonymization, de-identification, pseudonymization, and coding to mitigate data storage-related risks.”; “FS8-Use, Retention and Disposal: Ensure data is used only as legally permissible and solely for purposes that are relevant to and compatible with the purposes for which it was collected.)”; “FS9-Disclosure to Third Parties and Onward Transfer: Preserve the framework standards and protections for data when it is transferred to third-party organizations and/or across country borders.”; “FS10-Choice and Consent: Enable individuals to choose whether personal data about them is processed. Obtain and document prior permission where necessary and appropriate, and enable individual to opt-out of ongoing processing.”; “FS11-Access and Individual Rights: Enable individuals to access information about themselves, to amend, correct, and as appropriate, delete information that is inaccurate, incomplete, or outdated.”; “FS12-Data Integrity and Quality: Assure that data is kept sufficiently accurate, complete, relevant, and current consistent with its intended use.”; “FS13-Security: Protect data from loss, misuse, and unauthorized access, disclosure, alteration, or destruction.”; and “FS14-Transparency: Inform individuals about the ways in which data about them are processed and how to exercise their data-related rights.”.

Demonstrate includes 2 standards including: “FS15-Monitoring and Assurance: Evaluate and audit effectiveness of controls and risk-mitigation initiatives.”; and “FS16-Reporting and Certification: Demonstrate the effectiveness of your program and controls to management, the Board of Directors, employees, customers, regulators, and the public.”.

The below description is directed to core controls for managing framework database 412. As shown in the present embodiment, there are 55 core controls, shown as 1.1 through 3.7, which may be primarily utilized in managing controls framework database 412. 24 of these core controls (1.1 through 1.12) are utilized in building 460, 24 of these core controls (2.1 through 2.20.2) are utilized in implementing 470, and 7 core controls (3.1 through 3.7) are utilized in demonstrating 480, all of which may be utilized in managing controls framework database 412. In addition, each of these core controls corresponds to and is associated with one of the 16 framework standards. The applicable framework standard (FS1-FS16) is provided in parenthesis in the corresponding/associated core controls in the below description.

Build includes 24 core controls corresponding to 6 standards including: “1.1 (FS1) Identify internal stakeholders, Establish program leadership and governance, Define program mission, vision, and goals.”; “1.2 (FS1) Appoint a CPO, DPO, or other Privacy Leader.”; “1.3 (FS2) Identify, assess, and classify data-related strategic, operational, legal, compliance, and financial risks.”; “1.3.1 (FS2) Define objective criteria for assessing risks to individuals, the data, and the organization.”; “1.3.2 (FS2) Complete a program-level risk assessment and develop privacy program priorities and an implementation plan aligned to the outcomes of that assessment.”; “1.3.3 (FS2) Ensure that Privacy by Design (PbD) is based on an inherent risk analysis and incorporates appropriate controls for mitigating such risks.”; “1.3.4 (FS2) Develop data security program priorities and an implementation plan aligned to the outcomes of the program-level risk assessment.”; “1.3.5 (FS2) Where planned data processing presents a high inherent risk of harm to individuals based on objective criteria for assessing risks to individuals, ensure that privacy impact assessments address existing and potential risks identified in the organization by evaluating the effectiveness of controls mitigating such risks.”; “1.4 (FS3) Allocate appropriate resources to support the defined mission and vision, and to manage identified risks.”; “1.4.1 (FS3) Establish and maintain budgets for privacy program.”; “1.4.2 (FS3) Define privacy-related roles and responsibilities, Assign competent personnel and support their development.”; “1.5 (FS4) Develop policies, procedures, and guidelines to define and deploy effective and sustainable governance and controls for managing data-related risks.”; “1.5.1 Ensure the scope of policies, procedures, and guidelines is clearly defined.”; “1.5.2 Document and communicate updates to policies, procedures, and guidelines.”; “1.5.3 Ensure that policies and standards are enforceable.”; “1.6 (FS5) Establish, manage, measure, and continually improve processes for evaluating third parties to ensure that they have appropriate privacy and data protection safeguards in place.”; “1.7 (FS5) Establish, manage, measure, and continually improve processes for implementing and maintaining personal data processing inventory with data classification built in.”; “1.8 (FS5) Establish, manage, measure, and continually improve processes for developing, implementing, and periodically testing the effectiveness of a personal data incident management and breach response plan.”; “1.9 (FS5) Establish, manage, measure, and continually improve processes for assessing the inherent data processing risk for new, ongoing, and modified data processing based on objective criteria for assessing risks to individuals.”; “1.9.1 (FS5) Establish, manage, measure, and continually improve processes for completing privacy impact assessments (PIAs) to evaluate the effectiveness of controls mitigating such risks.”; “1.9.2 (FS5) Establish, manage, measure, and continually improve processes for implementing all necessary controls to mitigate risk to appropriate levels.”; “1.10 (FS5) Establish, manage, measure, and continually improve processes for establishing, implementing, publicizing and actively managing a privacy complaint handling process, including alternative dispute resolution as needed.”; “1.11 (FS5) Establish, manage, measure, and continually improve processes for establishing, implementing, and actively managing processes to honor individual rights such as access, correction, deletion, and data portability.”; and “1.12 (FS6) Communicate about the value and risks associated with data as well as program and process expectations, Provide both general and contextual training, including professional certification training, Reinforce messages periodically.”.

Implement includes 24 core controls corresponding to 8 standards including: “2.1 (FS7) Optimize data value by collecting and retaining only the data necessary for strategic goals, Leverage anonymization, de-identification, pseudonymization, and coding to mitigate data storage related risks.”; “2.2 (FS8) Ensure data is used solely for purposes that are relevant to and compatible with the purposes for which it was collected.”; “2.3 (FS8) Keep data in identifiable form only as long as necessary for identified processing purposes of which individuals have been informed, If data are needed for a longer period of time for researcher optimization-related purposes, implement coding, pseudonymization, or similar mechanisms to limit the risk to individuals.”; “2.4 (FS8) Ensure that all data processing is legally permissible, including any data disclosures to third parties.”; “2.5 (FS8) Define and communicate retention periods for personal data used by the process or technology.”; “2.6 (FS9) Assess vendors handling personal data for effective safeguards and controls.”; “2.7 (FS9) Execute appropriate contracts with vendors supporting the process or technology or with any third parties.”; “2.8 (FS9) Ensure personal data is adequately protected when transferred internationally, including transfers to third parties and vendors.”; “2.9 (FS10) Enable individuals to choose whether personal data about them is processed, Obtain and document prior permission (consent) where necessary and appropriate, and enable individual to opt out of ongoing processing.”; “2.9.1 (FS10) Ensure consent is clear and conspicuous, freely given, and able to be withdrawn at any time.”; “2.9.2 (FS10) Ensure that evidence of consent can be produced at any time.”; “2.10 (FS10) If the individual is a child (as defined by applicable law), obtain verifiable parental consent for the processing.”; “2.11 (FS10) Provide mechanisms for individuals to easily opt-out of ongoing processing about them.”; “2.12 (FS10) Enable individuals to access information about themselves, to amend, correct, and as appropriate, delete information that is inaccurate, incomplete, or outdated.”; “2.13 (FS11) Enable individuals to rectify inaccurate personal data processed by the technology, process, or activity.”; “2.14 (FS11) Where appropriate and in accordance with applicable law, enable individuals to delete personal data processed by the technology, process, or activity.”; “2.15 (FS11) Enable individuals to request reasonable restrictions on uses or disclosures of personal data about them where such restrictions do not adversely affect the rights of others, do not require disproportionate efforts for the organization to implement or where required by law.”; “2.16 (FS11) Where reasonable and practicable, enable individuals to access information about themselves in a machine-readable or electronic format consistent with its intended use.”; “2.17 (FS12) Assure that data are kept sufficiently accurate, complete, relevant, and current consistent with its intended use.”; “2.18 (FS13) Put in place administrative, physical, and technical safeguards to protect data from loss, misuse, and unauthorized access, disclosure, alteration, or destruction.”; “2.19 (FS13) Conduct security risk assessments as required by the security program, and remediate areas of identified risk.”; “2.20 (FS14) Inform individuals about the ways in which data about them are processed and how to exercise their data-related rights, including those arising out of data-related incidents and breaches.”; “2.20.1 (FS14) Ensure information about data processing and individuals rights is clear and conspicuous.”; and “2.20.2 (FS14) Ensure information about data processing and individuals' rights is provided before information is collected from individuals, at the time of collection, or as soon as practicable thereafter.”.

Demonstrate includes 7 core controls corresponding to 2 standards including: “3.1 (FS15) Continually monitor and periodically evaluate program maturity, and periodically assess and audit the effectiveness of program controls and risk-mitigation initiatives.”, “3.2 (FS16) Select and implement mechanisms to demonstrate the effectiveness of your program and controls to management, the Board of Directors, employees, customers, regulators, and the public.”; “3.3 (FS16) Establish a point of contact for direct cooperation with DPAs.”; “3.4 (FS16) Consider demonstrating compliance by adhering to binding and enforceable codes of conduct.”; “3.5 (FS16) Consider demonstrating compliance through certification, seals, and/or marks.”; “3.6 (FS16) Consider demonstrating corporate data responsibility to customers and the public as part of the organization's corporate social responsibility and/or sustainability goals.”; and “3.6 (FS16) If your organization is a data-driven business, consider demonstrating data stewardship, ethics, and accountability as part of the value of the organizational brand value.”.

FIG. 6 is a block diagram of an indexed core control framework 610 and a privacy management category framework 620 being cross-mapped into a combinatorial framework 600, in which various embodiments of the present invention may be implemented. In this embodiment, each core control may be indexed to various standards (e.g., laws and regulations) at the core control level. Some core controls may be deconstructed into discrete controls which may be indexed to multiple standards and referred to herein as common controls. Each privacy management category may include multiple types of activities. Individual activities may be indexed to various standards at the activity level. Some activities may be deconstructed into discrete activities which may be indexed to multiple standards and referred to herein as common activities. In the present embodiment, the core control framework is cross-mapped to the privacy management category framework, although other embodiments may cross-mapped the frameworks at alternative levels. For example, core controls and discrete controls may be cross-mapped directly with activities and discrete activities. The implementation can be a choice by one of ordinary skill in the art depending on the context in which the frameworks are implemented.

In the present embodiment, indexed core control framework 610 includes a pillar ID (identifier) 611, a framework standard ID 612, a CC (core control) ID 613, a set of standards 614 indexed to core control 613, and a cross reference or mapping to PMC (privacy management category) ID 615. A single entry 641 is shown in the indexed core control framework 610 for illustrative purposes in this example, but many such entries are generally included. In the present embodiment, privacy management category framework 620 includes pillar ID 621, PMC ID 622, activities 623 associated with given pillar ID 62 land PMC ID 622, and a cross reference or mapping to CC (core control) ID 624. Three entries 651, 652 and 653 are shown for illustrative purposes in this example, but many such entries are generally included. In this example, prior to cross mapping the frameworks, entry 641 references pillar implement, framework standard 1.2, core control 2.17 and standards GDPR Article 5.1(d) and CCPA section 3.7. In this example, core control is indexed with two different standards, so this core control may be referred to herein as a common control. Also in this example, entry 651 references pillar implement, privacy management category 1, activities A, B, C and D; entry 652 references pillar implement, PMC ID 2 as well as activities F, G and H; and entry 653 references pillar implement, PMC ID 9 as well as activities J, K, L. Initially there is no PMC ID 615 in core control framework 610 and no CC ID 624 in PMC framework 620. Those cross-references are added as described herein.

Core control framework 610 may then be cross-mapped with PMC framework 620. Some of this may be performed automatically by comparing indexed standards 614 with standards indexed with activities 623. In this example, core control framework 610 is cross-mapped with PMC framework 620 manually by those skilled in the art. This allows for some judgement by those skilled in the art as to which core controls are cross mapped with privacy management categories. In this example, entry 651 is not cross mapped with any core control, which may occur. However, in this example entry 641 is cross mapped with entries 652 and 653. As a result, PMC ID 661 will reference PID implement, PMC ID 2 as well as PMC implement and PMC ID 9. Furthermore, CC IDs 662 and 633 will reference P ID implement, FS ID 1.2 and CC ID 2.17. This results in each framework cross-referencing the other framework.

These cross mapped frameworks may be retained as separate frameworks in separate databases for further processing, or they may be combined into a single framework with cross mapped entries in a single database, or some hybrids thereof. One of ordinary skill in the art may choose which approach to utilize for further processing.

By cross-mapping the frameworks, the system is more dynamic and may be utilized in an improved manner. For example, in this example, activities F, G, H as well as activities J, K and L may be useful in complementing any standard 614 indexed to core control 2.17. This may be particularly useful if a given entity was subject to GDPR previously and now if subject to CCPA. That is, any cross mapped PMC activities implemented pursuant to compliance with the GDPR may be directly applicable to the CCPA, which can be indicated to an entity user automatically.

FIGS. 7A-7D provide diagrams of the framework database system and its application in which various embodiments of the present invention may be implemented. FIG. 7A provides a report 700 including an assessment of an entity's privacy controls 702 and privacy activities 704. Because the controls framework and the activities frameworks are cross mapped with each other, both of these assessments may be generated concurrently. Also, as a user drills down by asking for the same assessment specific for certain countries, business units or laws, both assessment reports may be provided concurrently during that drill down process.

FIGS. 7B-7D provide examples of utilizing these framework databases for accountability and compliance. FIG. 7B includes an illustration 710 of privacy management activities 711 utilized as evidence 712 across multiple different laws across multiple jurisdictions 713. FIG. 7B includes an illustration of an Accountability Based Approach which leverages existing activities with many laws and evidence of accountability to demonstrate compliance. That is, evidence of Privacy Management Activities 711 exists throughout the organization (within the privacy program as well as operations) evidence is collected in centralized repository, structured in a line with the Privacy Management “categories”. Evidence of accountability is mapped to requirements allowing the organization to demonstrate compliance with laws and regulations 713 on-demand, supported by evidence 712.

FIG. 7C (split into FIGS. 7C/1 and 7C/2) includes an illustration 720 of applying a combinatorial framework to the GDPR including identifying annotations of the GDPR 721, applying core controls 722 to those annotations, reviewing example accountability mechanisms 723 to provide example evidence 724 of compliance with the GDPR. For example, Accountability Annotation 721 may include Article 13 of GDPR including “Article 13—Controllers obligations to provide notice to data subjects. Article 13 provides that where personal data relating to data subjects are collected, controllers must provide certain minimum information to those data subjects through an information notice. It also sets out requirements for timing of the notice and identifies when exemptions may apply. See Recitals 60-62.” Technical or Organisational Measure 722 may include “Maintain a data privacy notice that details the organizations personal data handling practices—This privacy management activity ensures that controllers put in place policies and procedures to ensure that the required information is provided to data subjects when the information is collected”, “Maintain policies/procedures for secondary users or personal data—This privacy management activity addresses having policies and procedures that define how to handle situations when the organisation wishes to use personal data beyond the primary purpose. Secondary uses of data must be disclosed in information notices under Article 13 and 14” and “Provide data privacy notice at all points where personal data is collected—This privacy management activity addresses how an organisation provides an opportunity for data subjects to review the organisation's privacy notice at the point of data collection.” Example Accountability Mechanisms 733 may include “Data privacy notice”, “Just in Time Data Privacy Notice”, “Mobile Data Privacy Notice”, “Short Form/Condensed Data Privacy Notice”, “Translated Data Privacy Notice”, Privacy Notice Language for Hard Copy Forms”, “Privacy Notice Signage”, “Privacy Notice in Marketing Communications”, “Privacy Notice in Contracts and Terms”, and “Scripts for Providing Notice via Phone”. Example Evidence 734 may include “Copy the information notice provided to data subjects”, “Documentation showing that privacy notice is aligned to legal requirements”, “Details on the placements and timing of the notice”, “Copies of contracts showing requirements for privacy notice language”, and “Records for training sessions with call center reps providing instructions on how to provide notice via phone”.

FIG. 7D includes an illustration 740 of applying privacy management categories 741 for accountability across multiple compliance laws 742. This illustrates a global mapping of the framework with GDPR, CCPA, LGPD and BCRs compared.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages such as Java. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for utilizing a combinatorial framework system for risk management and compliance. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for utilizing a combinatorial framework system 350 for assessing risk management and compliance of an entity, comprising:
obtaining a master framework database for automating the management of a risk management and compliance program, the master framework database including a first framework database directed to mapping activities of the entity, the first framework also including comparable selected standard activities, and the master framework database including a second framework database directed to mapping controls of the entity, the second framework also including comparable selected standard controls, the first and second framework databases including cross referenced data elements;
accessing the first framework database to generate a first risk management and compliance analysis of the activities of the entity compared with selected standard activities applicable to the entity; and
accessing the second framework database to generate a second risk management and compliance analysis of the controls of the entity compared with selected standard controls applicable to the entity;
wherein during the first and second risk management and compliance analysis of the activities and the controls of the entity, utilizing the cross referenced data elements to identify previously implemented activities and controls of the entity.

2. The method of claim 1 further comprising responsive to the risk management and compliance analysis of the activities and the controls of the entity, utilizing the cross referenced data elements to provide tasks for implementing activities and controls for the entity.

3. The method of claim 1 wherein the comparable selected standard activities included in the first framework database are cross referenced with the comparable selected standards of the second framework database.

4. The method of claim 3 further comprising comparing the mapped controls of the entity with the comparable selected standard activities of the first framework database utilizing the cross references between the second and first framework databases.

5. The method of claim 3 further comprising comparing mapped activities of the entity with the selected standard controls of the second framework database utilizing the cross references between the first and second framework databases.

6. The method of claim 3 wherein tasks generated to address identified risks of mapped activities of the entity concurrently address identified risks of mapped controls of the entity utilizing the cross references between the first and second framework databases.

7. The method of claim 1 further comprising generating a drillable on-line report illustrating the risk management and compliance analysis of the activities of the entity compared with selected standard activities applicable to the entity, and illustrating the risk management and compliance analysis of the controls of the entity compared with selected standard controls applicable to the entity.

8. A data processing system for utilizing a combinatorial framework system for assessing risk management and compliance of an entity, the data processing system comprising:
a processor; and
a memory storing program instructions which when processed by the processor perform the steps of:
obtaining a master framework database for automating the management of an risk management and compliance program, the master framework database including a first framework database directed to mapping activities of the entity, the first framework also including comparable selected standard activities, and the master framework database including a second framework database directed to mapping controls of the entity, the second framework also including comparable selected standard controls, the first and second framework databases including cross referenced data elements;
accessing the first framework database to generate a first risk management and compliance analysis of the activities of the entity compared with selected standard activities applicable to the entity; and
accessing the second framework database to generate a second risk management and compliance analysis of the controls of the entity compared with selected standard controls applicable to the entity;
wherein during the first and second risk management and compliance analysis of the activities and the controls of the entity, utilizing the cross referenced data elements to identify previously implemented activities and controls of the entity.

9. The data processing system of claim 8 further comprising responsive to the risk management and compliance analysis of the activities and the controls of the entity, utilizing the cross referenced data elements to provide tasks for implementing activities and controls for the entity.

10. The data processing system of claim 8 wherein the comparable selected standard activities included in the first framework database are cross referenced with the comparable selected standards of the second framework database.

11. The data processing system of claim 10 further comprising comparing the mapped controls of the entity with the comparable selected standard activities of the first framework database utilizing the cross references between the second and first framework databases.

12. The data processing system of claim 10 further comprising comparing mapped activities of the entity with the selected standard controls of the second framework database utilizing the cross references between the first and second framework databases.

13. The data processing system of claim 10 wherein tasks generated to address identified risks of mapped activities of the entity concurrently address identified risks of mapped controls of the entity utilizing the cross references between the first and second framework databases.

14. The data processing system of claim 8 further comprising generating a drillable on-line report illustrating the risk management and compliance analysis of the activities of the entity compared with selected standard activities applicable to the entity, and illustrating the risk management and compliance analysis of the controls of the entity compared with selected standard controls applicable to the entity.

15. A computer usable program product for utilizing a combinatorial framework system for assessing risk management and compliance of an entity, the computer program product comprising a non-transitory computer readable storage medium having program instructions embodied therewith, the program instructions processed by a processing circuit to cause the device to perform a method comprising:
obtaining a master framework database for automating the management of an risk management and compliance program, the master framework database including a first framework database directed to mapping activities of the entity, the first framework also including comparable selected standard activities, and the master framework database including a second framework database directed to mapping controls of the entity, the second framework also including comparable selected standard controls, the first and second framework databases including cross referenced data elements;
accessing the first framework database to generate a first risk management and compliance analysis of the activities of the entity compared with selected standard activities applicable to the entity; and
accessing the second framework database to generate a second risk management and compliance analysis of the controls of the entity compared with selected standard controls applicable to the entity;
wherein during the first and second risk management and compliance analysis of the activities and the controls of the entity, utilizing the cross referenced data elements to identify previously implemented activities and controls of the entity.

16. The computer usable program product of claim 15 further comprising responsive to the risk management and compliance analysis of the activities and the controls of the entity, utilizing the cross referenced data elements to provide tasks for implementing activities and controls for the entity.

17. The computer usable program product of claim 15 wherein the comparable selected standard activities included in the first framework database are cross referenced with the comparable selected standards of the second framework database.

18. The computer usable program product of claim 17 further comprising comparing the mapped controls of the entity with the comparable selected standard activities of the first framework database utilizing the cross references between the second and first framework databases.

19. The computer usable program product of claim 17 further comprising comparing mapped activities of the entity with the selected standard controls of the second framework database utilizing the cross references between the first and second framework databases.

20. The computer usable program product of claim 17 wherein tasks generated to address identified risks of mapped activities of the entity concurrently address identified risks of mapped controls of the entity utilizing the cross references between the first and second framework databases.

21. The computer usable program product of claim 15 further comprising generating a drillable on-line report illustrating the risk management and compliance analysis of the activities of the entity compared with selected standard activities applicable to the entity, and illustrating the risk management and compliance analysis of the controls of the entity compared with selected standard controls applicable to the entity.
